(19) United States
(12) Patent Application Publication
(10) Pub. No.: US 2004/0193614 A1
(43) Pub. Date: Sep. 30, 2004

(54) Method and apparatus for accessing parameters embedded in object indentifiers

(76) Inventor: Radia J. Perlman, Carlisle, MA (US)

Correspondence Address: PARK, VAUGHAN & FLEMING LLP, 508 SECOND STREET, SUITE 201, DAVIS, CA, 95616, US

(21) Appl. No.: 10/396,892

(22) Filed: Mar. 24, 2003

(51) Int. Cl. G06F 7/00

(52) U.S. Cl. 707/100

(57) ABSTRACT

One embodiment of the present invention provides a system that facilitates accessing a parameter embedded within an object identifier. During operation, the system receives the object identifier, wherein the object identifier contains a string of values. Next, the system looks for a prefix within the object identifier, wherein the prefix indicates that a subsequent value in the object identifier is a parameter value. If the system detects such a prefix, the system obtains the parameter value from the subsequent value in the object identifier. Next, the system uses the parameter value to perform an operation related to the object identifier or to the associated object.

### BACKGROUND

1. Field of the Invention

The present invention relates to techniques for associating parameters with objects. More specifically, the present invention relates to a method and an apparatus for accessing a parameter embedded within an object identifier.

2. Related Art

As computer systems become increasingly more interconnected, it is becoming easier to communicate between millions of geographically distributed computer systems. In such an environment, it is often necessary to identify objects in a globally unique way. This can be accomplished by assigning identifiers to objects from a central repository. However, it is impractical to maintain such a central repository for a large number of computer systems, because the central repository is likely to become a bottleneck if many computer systems simultaneously request an identifier. Moreover, a central repository constitutes a single point of failure.

Furthermore, there has recently been a proliferation of protocols related to computer systems and computer networks in recent years. In order for these protocols to be extensible, it is desirable to be able to add fields for future uses. However, if independent organizations create fields, they might accidentally assign the same number, creating confusion. An alternative is central administration of numbers, but that requires bureaucratic overhead.

In order to solve these problems, the Abstract Syntax Notation One (ASN.1) X.208 specification has been developed, which allows object identifiers (OIDs) to be allocated hierarchically. An OID defined by the ASN.1 X.208 specification consists of a string of values delimited by dots. This string of values identifies an object in a globally unique way.

OIDs can be allocated hierarchically. This means that once an entity obtains a valid OID, for example “1.2.3”, the entity is free to assign derivative OIDs with the prefix “1.2.3”. For example, the entity can assign the OIDs “1.2.3.97” and “1.2.3.147”. Note that there is no limit to the length of an OID.

The entity is also free to assign these derivative OIDs to other entities, which enables the other entities to assign their own OIDs. For example, referring to FIG. 1, if entity 102 obtains a prefix 1.2.3, entity 102 can assign derivative OIDs 1.2.3.15 and 1.2.316 to entities 103 and 104, respectively. This enables entities 103 and 104 to assign OIDs beginning with the prefixes 1.2.3.15 and 1.2.3.16, respectively. Once entity 104 obtains OID 1.2.3.16, entity 104 can assign prefixes 1.2.3.16.1 and 1.2.3.16.2 to entities 105 and 106, respectively. This allows entities 105 and 106 to construct OIDs beginning with 1.2.3.16.1 and 1.2.3.16.2, respectively.

OIDs are presently used only to identify objects. Consequently, OIDs are only tested for equality. This means that there is no convenient way to associate a set of parameters with an OID. Hence, a different OID must be assigned for each object/parameter set. Alternatively, the parameter set can be maintained outside of the object identifier in a manner that allows the parameter set to be propagated along with the OID.

This inability to associate parameters with an OID can create problems. For example, the X.509 standard for digital certificates defines a single field for specifying a policy used in issuing digital certificates. In some cases it may be useful to associate a parameter, for example, specifying a “carefulness value” with the policy. For example, the parameter can specify a security level of a person who enforces the certificate issuing policy. However, it is not a simple matter to associate a parameter with such a policy because the X.509 standard only provides a single field to specify the policy. Note that it is possible to create a different policy for every conceivable policy/parameter pair. However, this can lead to an explosion in the number of policies.

Hence, what is needed is a method and an apparatus for associating parameters with identifiers without the problems described above.

### SUMMARY

One embodiment of the present invention provides a system that facilitates accessing a parameter embedded within an object identifier. During operation, the system receives the object identifier, wherein the object identifier contains a string of values. Next, the system looks for a prefix within the object identifier, wherein the prefix indicates that a subsequent value in the object identifier is a parameter value. If the system detects such a prefix, the system obtains the parameter value from the subsequent value in the object identifier. Next, the system uses the parameter value to perform an operation related to the object identifier or to the associated object.

In a variation on this embodiment, the system is configured to construct the object identifier by inserting the prefix into the object identifier, and then embedding the parameter value into a subsequent value, which follows the prefix in the object identifier.

In a variation on this embodiment, the object identifier is an OID defined by the Abstract Syntax Notation One (ASN.1) X.208 specification.

In a variation on this embodiment, values in the object identifier are separated by dots, which delimit the values.

In a variation on this embodiment, obtaining the parameter value can involve obtaining multiple parameter values from multiple subsequent values in the object identifier.

In a variation on this embodiment, object identifiers are hierarchical, whereby if an entity is assigned a given object identifier, the entity can assign derivative object identifiers that include the given object identifier as a prefix.

In a variation on this embodiment, the system obtains the parameter value by first reading a parameter identifier following the prefix in the object identifier, wherein the parameter identifier identifies a following parameter value in the object identifier. Next, the system reads the parameter value from the following value in the object identifier.

### BRIEF DESCRIPTION OF THE DRAWINGS

FIG. 1 illustrates how object identifiers are assigned in a hierarchical manner.

FIG. 2 presents a flow chart illustrating the process of embedding a parameter value into an object identifier in accordance with an embodiment of the present invention.

FIG. 3 presents a flow chart illustrating the process of retrieving a parameter from an object identifier in accordance with an embodiment of the present invention.

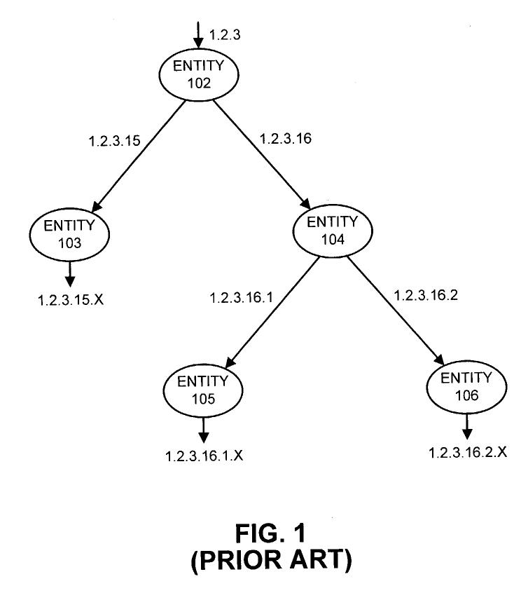

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Process of Embedding a Parameter Value into an Object Identifier

The present invention operates by overloading parameters into an OID, so that additional components of the OID are actually parameter values associated with the OID (or the related object). For example, if an algorithm is assigned an OID “a.b.c.d” and takes three parameters with values “k, l, and m,” then the OID a.b.c.d.k.l.m specifies the algorithm a.b.c.d with the parameter values k, l, and, m.

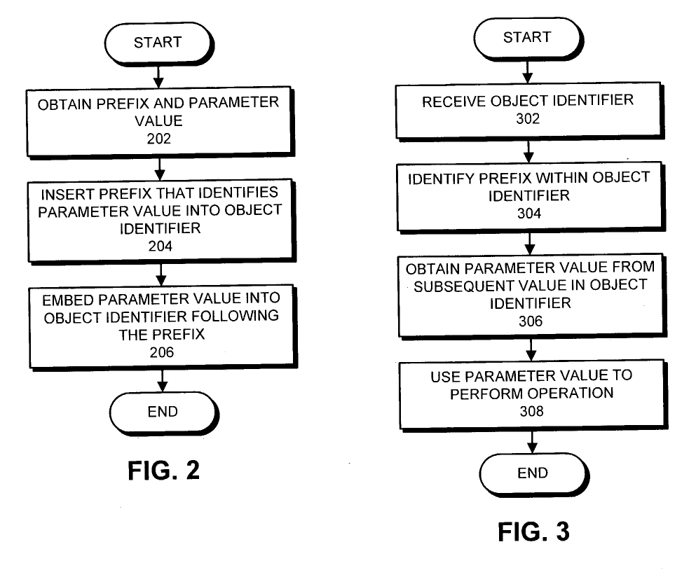

FIG. 2 presents a flow chart illustrating the process of embedding a single parameter value into an object identifier in accordance with an embodiment of the present invention. First, the system obtains a prefix and a parameter value associated with the object (step 202). Next, the system constructs an OID for the object by inserting the prefix into the OID (step 204). The system then embeds the parameter value into the OID (step 206). Although the process illustrated in FIG. 2 only inserts a single parameter value into an OID, in general the system can embed more than one parameter value into the OID.

### Process of Retrieving a Parameter Value from an Object Identifier

FIG. 3 presents a flow chart illustrating the process of retrieving a parameter from an object identifier in accordance with an embodiment of the present invention. Upon receiving the OID (step 302), the system attempts to identify a prefix in the OID, which indicates that a subsequent value in the OID contains a parameter value (step 304). If such a prefix is identified, the system obtains the parameter value from the subsequent value (step 306). Next, the system uses the parameter value to perform an operation (step 308).

Note that this operation can be more than just a simple comparison operation. It can generally include any type of function or operation that can use a parameter value. For example, if the parameter value represents a person's date of birth, the system can test the parameter value to make certain that the person is at least 18 years of age.

Although the process illustrated in FIG. 3 only retrieves a single parameter value, in general, the system can retrieve more than one parameter value into an OID.

Note that OIDs can be assigned to any type of object, including physical objects, such as manufactured items, buildings or people, and abstract objects, such as algorithms or objects defined within an object-oriented programming system. Furthermore, OIDs can be assigned by any type of entity. For example, an OID can be assigned by a person, an organization or by an application within a computer system.

In one embodiment of the present invention, a parameter identifier can precede the parameter value. For example, if a person is assigned an OID “1.2.3,” the OID 1.2.3.15.2 can be constructed for the person, wherein the value 15 is a parameter identifier indicating that the following parameter specifies the hair color of the person, and the following parameter value 2 indicates that the hair color for the person is brown. Similarly, an OID 1.2.3.17.67 can be constructed for the person, wherein the value 17 is a parameter identifier indicating that the following parameter specifies the height of the person, and the following parameter value 67 indicates that the person is 67″ tall.

It is also possible to combine multiple parameter identifiers and parameter values into a single OID. For example, the OID 1.2.3.15.2.17.67 can be constructed for a person, wherein the values “15.2” specify that the hair color for the person is brown and the values “17.67” specify that the person is 67″ tall. Note that the values can also appear in the other order 1.2.3.17.67.15.2.

In another example, a policy field in an X.509 certificate can contain an OID that specifies a policy used in issuing a digital certificate, as well as parameter values associated with the policy. Assume that the prefix 1.2.3.4 represents a specific policy for issuing digital certificates. The OID 1.2.3.4.18.3.19.70 can be constructed for the policy. The value 18 in this OID is a parameter identifier indicating that the following parameter specifies the number of forms of identification that were examined before issuing the digital certificate. The following parameter value 3 indicates that three forms of identification were examined. (Alternatively, the following values in the OID can include a list of different types of identification that were examined, such as a driver's license, a social security card and a credit card.) The value 19 in the OID 1.2.3.4.18.3.19.70 is a parameter identifier indicating that the following parameter specifies a security level (from 1-100) of a person who examined the forms of identification. The following parameter value 70 indicates that the security level of the person is 70.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for accessing a parameter embedded within an object identifier, comprising:
receiving the object identifier, wherein the object identifier contains a string of values;
identifying a prefix within the object identifier, wherein the prefix indicates that a subsequent value in the object identifier contains a parameter value;
obtaining the parameter value from the subsequent value in the object identifier; and
using the parameter value to perform an operation related to the object identifier or the associated object.

2. The method of claim 1, wherein prior to receiving the object identifier, the method further comprises constructing the object identifier by:
inserting the prefix into the object identifier;
obtaining the parameter value; and
embedding the parameter value into the subsequent value, which follows the prefix in the object identifier.

3. The method of claim 1, wherein the object identifier is an OID defined by the Abstract Syntax Notation One (ASN.1) X.208 specification.

4. The method of claim 1, wherein values in the object identifier are separated by dots, which delimit the values.

5. The method of claim 1, wherein obtaining the parameter value can involve obtaining multiple parameter values from multiple subsequent values in the object identifier.

6. The method of claim 1, wherein object identifiers are hierarchical, whereby if an entity is assigned a given object identifier, the entity can assign derivative object identifiers that include the given object identifier as a prefix.

7. The method of claim 1, wherein obtaining the parameter value involves:
reading a parameter identifier following the prefix in the object identifier, wherein the parameter identifier identifies a following parameter value in the object identifier; and then
reading the parameter value from the following value in the object identifier.

8. The method of claim 7, wherein the object identifier can include multiple (parameter identifier, parameter value) pairs that can appear in any order in the object identifier.

9. A computer-readable storage medium storing instructions that when executed by a computer cause the computer to perform a method for accessing a parameter embedded within an object identifier, the method comprising:
receiving the object identifier, wherein the object identifier contains a string of values;
identifying a prefix within the object identifier, wherein the prefix indicates that a subsequent value in the object identifier contains a parameter value;
obtaining the parameter value from the subsequent value in the object identifier; and
using the parameter value to perform an operation related to the object identifier or the associated object.

10. The computer-readable storage medium of claim 9, wherein prior to receiving the object identifier, the method further comprises constructing the object identifier by:
inserting the prefix into the object identifier;
obtaining the parameter value; and
embedding the parameter value into the subsequent value, which follows the prefix in the object identifier.

11. The computer-readable storage medium of claim 9, wherein the object identifier is an OID defined by the Abstract Syntax Notation One (ASN.1) X.208 specification.

12. The computer-readable storage medium of claim 9, wherein values in the object identifier are separated by dots, which delimit the values.

13. The computer-readable storage medium of claim 9, wherein obtaining the parameter value can involve obtaining multiple parameter values from multiple subsequent values in the object identifier.

14. The computer-readable storage medium of claim 9, wherein object identifiers are hierarchical, whereby if an entity is assigned a given object identifier, the entity can assign derivative object identifiers that include the given object identifier as a prefix.

15. The computer-readable storage medium of claim 9, wherein obtaining the parameter value involves:
reading a parameter identifier following the prefix in the object identifier, wherein the parameter identifier identifies a following parameter value in the object identifier; and then
reading the parameter value from the following value in the object identifier.

16. The computer-readable storage medium of claim 15, wherein the object identifier can include multiple (parameter identifier, parameter value) pairs that can appear in any order in the object identifier.

17. An apparatus that facilitates accessing a parameter embedded within an object identifier, comprising:
a receiving mechanism configured to receive the object identifier, wherein the object identifier contains a string of values;
a prefix identification mechanism configured to identify a prefix within the object identifier, wherein the prefix indicates that a subsequent value in the object identifier contains a parameter value;
a reading mechanism configured to obtain the parameter value from the subsequent value in the object identifier; and
an execution mechanism configured to use the parameter value to perform an operation related to the object identifier or the associated object.

18. The apparatus of claim 17, further comprising an object identifier construction mechanism, configured to:
insert the prefix into the object identifier;
obtain the parameter value; and to
embed the parameter value into the subsequent value, which follows the prefix in the object identifier.

19. The apparatus of claim 17, wherein the object identifier is an OID defined by the Abstract Syntax Notation One (ASN.1) X.208 specification.

20. The apparatus of claim 17, wherein values in the object identifier are separated by dots, which delimit the values.

21. The apparatus of claim 17, wherein the reading mechanism is configured to obtain multiple parameter values from multiple subsequent values in the object identifier.

22. The apparatus of claim 17, wherein object identifiers are hierarchical, whereby if an entity is assigned a given object identifier, the entity can assign derivative object identifiers that include the given object identifier as a prefix.

23. The apparatus of claim 17, wherein the reading mechanism is configured to:
read a parameter identifier following the prefix in the object identifier, wherein the parameter identifier identifies a following parameter value in the object identifier; and to
read the parameter value from the following value in the object identifier.

24. The apparatus of claim 23, wherein the object identifier can include multiple (parameter identifier, parameter value) pairs that can appear in any order in the object identifier.
